(19) United States
(12) Patent Application Publication
(10) Pub. No.: US 2005/0223157 A1
(43) Pub. Date: Oct. 6, 2005

(54) Fast non-volatile random access memory in electronic devices

(76) Inventors: Matti Floman, Kangasala (FI); Jani Klint, Tampere (FI); Jukka-Pekka Vihmalo, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/817,448

(22) Filed: Apr. 2, 2004

(51) Int. Cl. G06F 12/00

(52) U.S. Cl. 711/103; 711/167

(57) ABSTRACT

The present invention describes a novel methodology for a direct communication between a memory module and a processor of an electronic device (e.g., a mobile phone) using a fast non-volatile random access memory (NVRAM) provided in that memory module. New NVRAM technologies make it possible to have a single memory unit supporting a baseband operation of the electronic device such as the mobile phone. This is possible because NVRAMs are non-volatile (no need for a separate NOR) and fast (equivalent to a DRAM speed). This invention defines ways to connect the fast NVRAM to a baseband communication line through an existing mobile double data rate (DDR) interface. The invention also demonstrates flexibility and extended capabilities of the NVRAM approach by using the NVRAMs in combination with additional optional components such as a mass memory, a dynamic random access memory (DRAM) and an application-specific integration circuit.

### FIELD OF THE INVENTION

This invention generally relates to memories in electronic devices, and more specifically to providing a direct communication between a memory module and a processor of the electronic device using a fast non-volatile random access memory provided in that memory module.

### BACKGROUND OF THE INVENTION

In modem mobile phones supporting baseband designs there are separate volatile (e.g., random access memory) and non-volatile memories (typically NOR Flash type). This approach has problems potentially related to a physical size of such memories as well as their performance and flexibility (e.g., speed, ability to handle CMOS logic process, etc.) in a number of memory devices, especially in portable electronic devices, such as mobile electronic devices or mobile phones.

One of the strongest requirements for supporting today's baseband designs is a physical size of the electronic devices. It is not enough anymore to define a perfect interface and a memory IC behind it. In a modem mobile phone environment it is a strong need for reducing the physical size of the electronic devices, for multi-sourcing and for flexibility of changing memory technologies as well as memory capabilities. Therefore it is desirable to come out with new approaches to a memory design in the electronic devices to meet these challenges.

### SUMMARY OF THE INVENTION

The object of the present invention is to provide a novel method of a direct communication between a memory module and a processor of an electronic device (e.g., a portable electronic device, a mobile electronic device or a mobile phone) using a fast non-volatile random access memory (NVRAM) provided in that memory module.

According to a first aspect of the invention, a memory module of an optionally portable electronic device having a processor which optionally provides an overall operation control of said electronic device, comprises: a fast non-volatile random access memory, responsive to a command/data signal provided by said processor, for providing a permanent storage of information before said command/data signal is provided, for executing a command contained in said command/data signal using said permanently stored information thus providing a direct communication between said fast non-volatile random access memory and the processor of said optionally portable electronic device.

Further according to the first aspect of the invention, the interface between the processor and the fast non-volatile random access memory may be a double data rate (DDR) type.

Still further according to the first aspect of the invention, the fast non-volatile random access memory can provide a temporal storage of data contained in said command/data signal. Further, the fast non-volatile random access memory may comprise: an information storage area for the permanent storage of said information; and a temporal data storage area for the temporal storage of said data. Still further, the fast non-volatile random access memory may further comprise: at least one register for setting operating parameters of the fast non-volatile random access memory or protecting said data or said information during said execution. Yet further, said operating parameters may contain timings for a particular frequency, or frequency ranges with a corresponding core voltage range, or both said timings and said frequency ranges. Yet still further, said protecting can contain a write protection.

According further to the first aspect of the invention, the information may contain an application program for operating said electronic device.

According still further to the first aspect of the invention, the memory module may further comprise: a mass memory, for providing further information in response to a command/information signal; and an application-specific integration circuit, responsive to said command/data signal, for providing said command/information signal. Further, said further information may be provided to said fast non-volatile random access memory. Further still, said fast non-volatile random access memory may execute a further command contained in said command/data signal using said further information. Yet further, an interface between the application-specific integration circuit and the fast non-volatile random access memory may be a double data rate (DDR) type. Yet further still, a non-volatile random access memory-integrated circuit (NVRAM-IC) package may contain the application-specific integration circuit, the mass memory and the fast non-volatile random access memory, or said non-volatile random access memory-integrated circuit (NVRAM-IC) package may contain the application-specific integration circuit and the fast non-volatile random access memory, or said non-volatile random access memory-integrated circuit (NVRAM-IC) package may contain the mass memory and the fast non-volatile random access memory.

According further still to the first aspect of the invention, the memory module may further comprise: a dynamic random access memory, responsive to a command/data signal, for providing a storage of said further information, wherein said further information is provided or partially provided to the dynamic random access memory by the mass memory in response to said command/information signal. Further, a non-volatile random access memory-integrated circuit (NVRAM-IC) package may contain the application-specific integration circuit, the mass memory, the fast non-volatile random access memory and the dynamic random access memory, or said non-volatile random access memory-integrated circuit (NVRAM-IC) package may contain the application-specific integration circuit and the fast non-volatile random access memory, or said non-volatile random access memory-integrated circuit (NVRAM-IC) package may contain the mass memory, the dynamic random access memory and the fast non-volatile random access memory. Still further, said dynamic random access memory may execute a still further command contained in said command/data signal using said further information.

According yet further still to the first aspect of the invention, said portable electronic device may comprise: removable mass memory, for providing, in response to a further command/information signal provided by the application-specific integration circuit, still further information to the fast non-volatile random access memory, or to the dynamic random access memory, or to both the fast non-volatile random access memory and to the dynamic random access memory. Further, said fast non-volatile random access memory or the dynamic random access memory or both the fast non-volatile random access memory and the dynamic random access memory may execute a further command or a still further command or both the further command and the still further command contained in said command/data signal using said further information or said still further information or both the further information and the still further information.

Yet still further according to the first aspect of the invention, said fast non-volatile random access memory may be a magneto-resistive random access memory, a ferroelectric random access memory, or an Ovonics memory type.

According to a second aspect of the invention, an electronic device comprises: a processor, for providing a command/data signal and optionally for providing an overall operation control of said electronic device; and a fast non-volatile random access memory, responsive to the command/data signal, for providing a permanent storage of information before said command/data signal is provided, for executing a command contained in said command/data signal using said stored information.

According further to the second aspect of the invention, the electronic device may further comprise: a power and reset block, for resetting said processor and for resetting said fast non-volatile random access memory.

Further according to the second aspect of the invention, the electronic device may be a portable electronic device, a mobile electronic device or a mobile phone.

According to a third aspect of the invention, a method for providing a direct communication between a memory module of an optionally portable electronic device and a processor of said electronic device, said processor optionally providing an overall operation control of said electronic device, comprises the steps of: providing a command/data signal to a fast non-volatile random access memory of said memory module by said processor; and executing by said fast non-volatile random access memory a command contained in said command/data signal using information permanently stored by said fast non-volatile random access memory before said command/data signal is provided, thus providing a direct communication between said fast non-volatile random access memory and the processor of said optionally portable electronic device.

According further to the third aspect of the invention, the method may further comprise the step of: determining whether a further information is stored in a mass memory or a still further information is stored in a removable mass memory, wherein said further information or said still further information or both said further information and said still further information are needed to be accessed by the processor. Further, if said further information or said still further information or both said further information and said still further information are needed to be accessed by the processor, the method may further comprise the step of: determining by an application-specific integration circuit whether said fast non-volatile random access memory has enough of a storage area to accommodate said needed information. Still further, an interface between the application-specific integration circuit and the fast non-volatile random access memory may be a double data rate (DDR) type. Yet further, if said fast non-volatile random access memory has enough of said storage area to accommodate said needed information, the method may further comprise the steps of: copying said needed information to said fast non-volatile random access memory in response to a command/information signal provided by the application-specific integration circuit to a mass memory, or to a further command/information signal provided by the application-specific integration circuit to a removable mass memory or in response to both the command/information signal and the further command/information signal; and executing by said fast non-volatile random access memory a further command contained in the command/data signal using said needed information copied to said fast non-volatile random access memory before said command/data signal is provided. Yet further still, if said fast non-volatile random access memory does not have enough of said storage area to accommodate said needed information, the method further may comprise the steps of: copying said needed information partially to said fast non-volatile random access memory and partially to a dynamic random access memory in response to a command/information signal provided by the application-specific integration circuit to a mass memory, or to a further command/information signal provided by the application-specific integration circuit to a removable mass memory or in response to both the command/information signal and the further command/information signal; and executing a further command contained in the command/data signal by said fast non-volatile random access memory and executing a still further command also contained in the command/data signal by said dynamic random access memory using said needed information copied to said fast non-volatile random access memory and to said dynamic random access memory before said command/data signal is provided.

Further according to the third aspect of the invention, an interface between the processor and the fast non-volatile random access memory may be a double data rate (DDR) type.

Still further according to the third aspect of the invention, said fast non-volatile random access memory may be a magneto-resistive random access memory, a ferroelectric random access memory, or an Ovonics memory type.

According further to the third aspect of the invention, the electronic device is a portable electronic device, a mobile electronic device or a mobile phone.

According to a fourth aspect of the invention, a computer program product comprises: a computer readable storage structure embodying computer program code thereon for execution by a computer processor with said computer program code, characterized in that it includes instructions for performing all or selected steps of the third aspect of the invention indicated as being performed by any component of the memory module or their combination thereof.

The present invention reduces the amount of memory dies necessary for supporting the appropriate baseband designs. Since, according to the present invention, only one memory die is needed it is possible to reduce the amount of memory interfaces and simplify an application-specific integration circuit (ASIC) design and save pins in the ASICs. It also provides dramatically faster memory architecture compared to the traditional SRAM-NOR architecture.

Furthermore, in case of the mass memory connected to the ASIC through a RAM IC NVRAM, the process provides a much better solution than the DRAM process. The main reason for this is that the DRAM process is strongly optimized for a RAM usage and it is not optimized for logic operations as in the case of a fast NVRAM logic compliant CMOS process, according to the present invention.

### BRIEF DESCRIPTION OF THE DRAWINGS

For a better understanding of the nature and objects of the present invention, reference is made to the following detailed description taken in conjunction with the following drawings, in which:

FIG. 1a shows an example of a general block diagram of a memory module of an electronic device utilizing a fast non-volatile random access memory, according to the present invention.

FIG. 1b shows an example of a basic memory module of an electronic device utilizing a fast non-volatile random access memory, according to the present invention.

FIGS. 2a and 2b show further examples of memory modules of an electronic device utilizing a non-volatile random access memory-integrated circuit (NVRAM-IC) package, according to the present invention.

FIG. 3 shows an example of a fast non-volatile random access memory, according to the present invention.

FIG. 4 is a flow chart demonstrating a performance of a memory module of an electronic device of FIG. 1 a utilizing a fast non-volatile random access memory, according to the present invention.

### BEST MODE FOR CARRYING OUT THE INVENTION

The present invention provides a novel methodology for a direct communication between a memory module and a processor of an electronic device (e.g., a portable electronic device, a mobile electronic device or a mobile phone) using a fast non-volatile random access memory (NVRAM) provided in that memory module. New NVRAM technologies make it possible to have a single memory unit supporting a baseband operation of an electronic device such as the mobile phone. This is possible since NVRAMs are non-volatile (no need for a separate NOR) and fast (equivalent to a DRAM speed).

This invention defines ways to connect the fast NVRAM to a baseband communication line through an existing mobile double data rate (DDR) interface. This is possible to do without additional signals since the NVRAMs do not need additional pins for programming a voltage or a write protection as the NORs do.

The invention also demonstrates flexibility and extended capabilities of the NVRAM approach by using the NVRAMs in combination with additional optional components in the memory module such as a mass memory, a dynamic random access memory (DRAM) and an application-specific integration circuit (ASIC). Also a removable mass memory can be used with the application-specific integration circuit for further extending the capabilities of the NVRAM approach.

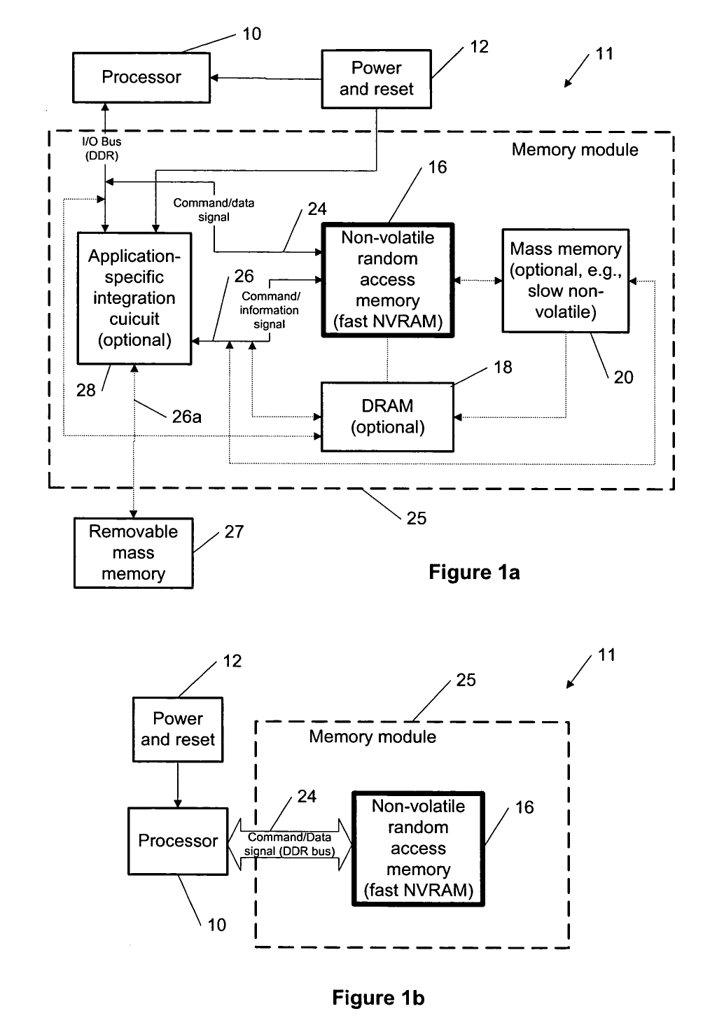

FIG. 1a shows a block diagram of one general example among many others of a memory module 25 of an electronic device 11 (e.g., a portable electronic device, a mobile electronic device or a mobile phone) utilizing a fast non-volatile random access memory (NVRAM) 16 provided in the memory module 25, according to the present invention.

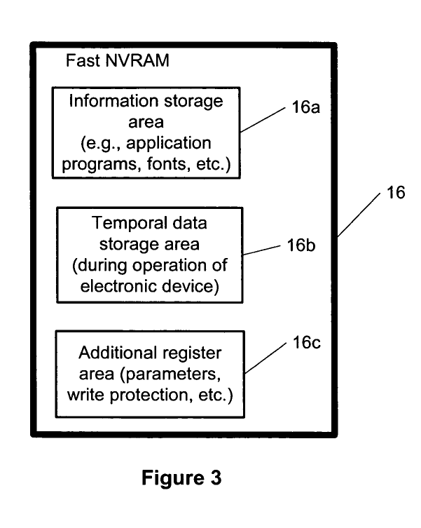

The electronic device 11 has a processor 10 which typically provides an overall operation control of said electronic device 11. The fast non-volatile random access memory (NVRAM) 16 is responsive to a command/data signal 24 (read, write, address, data, etc.) provided by said processor 10 by executing a command contained in said command/data signal 24 using information (e.g., application program, fonts, etc.) permanently stored in the NVRAM before said command/data signal 24 is provided (see FIG. 3 of the present invention for more details), thus providing a direct communication between said fast NVRAM 16 and the processor 10 of the electronic device 11.

According to the present invention, for example, it is possible to connect the fast NVRAMs to a baseband mobile communication network through an existing mobile DDR interface. This is because the fast NVRAMs are non-volatile (no need for a separate NOR) and fast (equivalent to a DRAM speed) as mentioned earlier. Thus in a preferred embodiment of the present invention an interface between the processor 10 and the fast NVRAM 16 is a double data rate (DDR) type. Using NVRAMs in a multiplexed NOR interface is not optimum for the fast NVRAMs, however, this can be a temporal optimum solution for some low end systems (for example, a today's Nokia single chip baseband system not having the DDR interface) as an intermediate solution before the DDR interface is available.

Furthermore, according to the present invention, for extending flexibility and capabilities of the NVRAM approach, the fast NVRAMs can be used in a combination with additional optional components in the memory module 25 such as a mass memory 20, a dynamic random access memory (DRAM) 18 and an application-specific integration circuit (ASIC) 28. Also a removable mass memory 27 can be used with the application-specific integration circuit 28 for further extending the capabilities of the NVRAM approach.

The optional mass memory 20 can be used for storing and providing further information (which is not stored in the NVRAM 16) to expand the capabilities of the NVRAM 16. If said mass memory 20 is used, the ASIC 28 is added to the memory block 25 (typically connected to the processor 10 by an I/O DDR bus) in order to facilitate a transfer (copying) of said further information to the NVRAM 16, so it can be accessed by the processor 10 in response to a further command (using said command/data signal 24) as described above. This transfer (copying) occurs in response to a command/information signal 26 provided by the ASIC 28.

Furthermore, the optional DRAM 18 can be used to overcome NVRAM's memory capacity limitations. Again the transfer (copying) or partial transfer (assuming that a part of the further information is copied to the NVRAM 16) of the further information to the DRAM 18 from the mass memory 20 occurs in response to a command/information signal 26 provided by the ASIC 28, so it can be accessed by the processor 10 in response to a still further command (using said command/data signal 24) as described above following a normal (per the prior art) operation of the DRAM 18.

Again, an interface between the application-specific integration circuit 28 and the fast NVRAM 16 is a double data rate (DDR) type in a preferred embodiment of the present invention. Using the NVRAMs in a multiplexed NOR interface is not optimal for the fast NVRAMs, however, this can be an intermediate optimum solution for some low end systems (for example, a today's Nokia single chip baseband system not having the DDR interface), for example, as an intermediate solution before the DDR interface is available.

There are several optimum solutions for implementing the NVRAMs using integrated circuits (ICs) including (but not limited to) a single IC in a CSP (chip-scale or chip-size packaging) package, multiple memory ICs in a stacked package, and the ASIC 28 and one or more memory ICs in the stacked package. The single IC in the CSP package can be an optimum solution utilizing a ×16 mobile DDR package already available. Using multiple memories in the stacked package, e.g., using POP (package-on-package) packaging, is more complicated but at the same time can be beneficial because it provides a possibility to make connections directly between memory dies. For example, it can be possible to have the fast NVRAM 16 connected to the ASIC 28 and the ASIC 28 can have connection to the mass memory 20 (slower IC memory) through the same fast NVRAM 16. This kind of implementation makes it possible to use the fast NVRAM 16 in XIP (execute In Place) architectures and if needed with cheap NAND or equivalent for IC based mass memory solutions. It is also possible to have a DRAM 18 IC in the same package to overcome the NVRAM's memory capacity limitation (as described above). The DRAM 18 can either have its own external pins or it can be accessed through the NVRAM 16 as shown in FIG. 1a. Also, according to the present invention, the mass memory 20 can be connected, in one possible scenario, through an HS-MMC (high speed-Multi Media card) interface or, in general, through a memory (optionally removable) card and the DRAM 18 can be connected through the same interface as the fast NVRAM 16 or through a separate interface if the performance optimization is a target.

Moreover, according to the present invention, the electronic device 11 can have a removable mass memory 27 (e.g., a CD or a hard disk), for providing, in response to a further command/information signal 26a provided by the ASIC 28, still further information to the fast NVRAM 16, to the DRAM 18 or to both the fast non-volatile random access memory 16 and to the DRAM 18. The still further information can be accessed by the processor 10 in response to a further command or a still further command or both commands using said command/data signal 24 as described above.

According to the present invention, the fast NVRAM 16 can be, for example, a magneto-resistive random access memory (MRAM), a ferroelectric random access memory (FeRAM), an Ovonics type memory or any other type of emerging technologies.

According to the present invention, said electronic device 11 can be a portable electronic device, a mobile electronic device or a mobile phone. Furthermore, said electronic device 11 can have a power and reset block 12, for resetting the processor 10 and the fast NVRAM 16.

FIG. 1b shows a block diagram of a basic (most simple) example of a memory module 25 of an electronic device 11 (e.g., a portable electronic device, a mobile electronic device or a mobile phone) utilizing the fast NVRAM 16 provided in the memory module 25, according to the present invention. In this example the NVRAM 16 is directly connected to the processor 10 through the I/O DDR bus. No ASIC 28 is needed in this example because no additional mass memories or DRAMs are used.

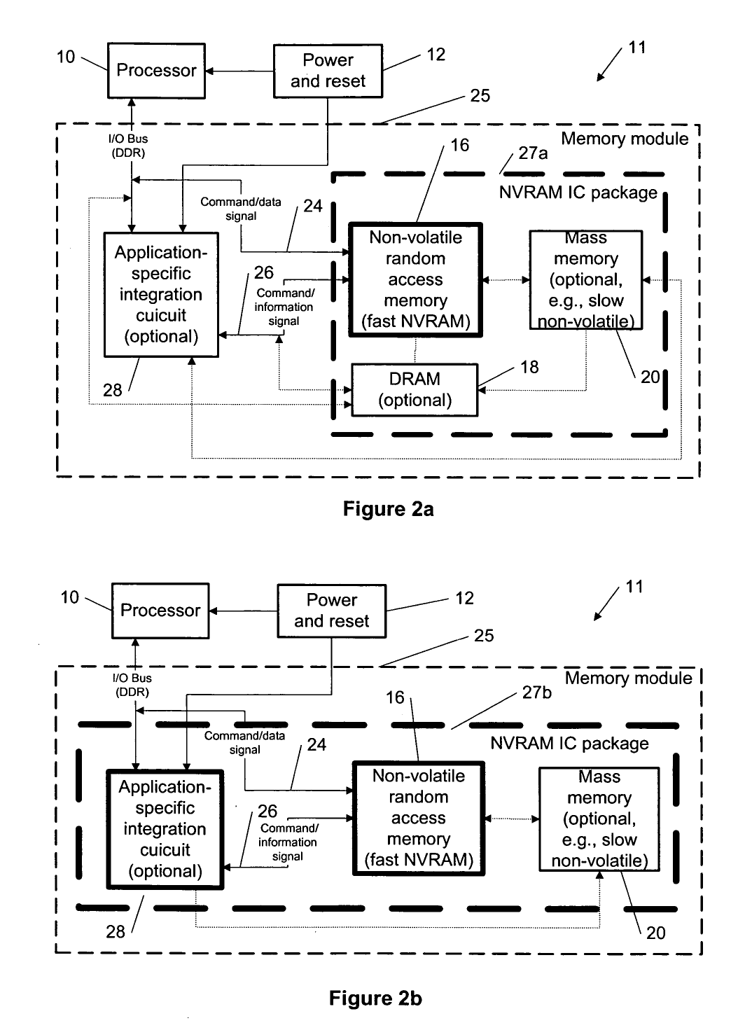

FIGS. 2a and 2b show further examples among many others of a memory module 25 of an electronic device 11 utilizing a non-volatile random access memory-integrated circuit (NVRAM-IC) packages 27a and 27b, respectively, according to the present invention. The NVRAM-IC package 27a (see FIG. 2a) includes the fast NVRAM 16, the mass memory 20 and the DRAM 18 and does not include the ASIC 28. However, in an alternative implementation of the present invention, the ASIC 28 can be included in the NVRAM-IC package 27a as well. The NVRAM-IC package 27b (see FIG. 2a) includes the fast NVRAM 16, the mass memory 20 and the ASIC 28, whereas the DRAM 18 is not a part of the memory module 25 for this example of FIG. 2b, according to the present invention. Other examples of components incorporated in the NVRAM-IC package 27a are also possible, e.g., containing only the fast NVRAM 16 and the ASIC 28, or containing only the fast NVRAM 16 and the mass memory 20, or containing only the fast NVRAM 16 and the DRAM 18, etc.

FIG. 3 shows an example among others of a content of the fast NVRAM 16, according to the present invention. Generally, the fast NVRAM 16 can comprise an information storage area 16a for the permanent storage of the information and/or the further information and/or the still further information described above. Said information (and/or the further information and/or the still further information) contains, e.g., an application program for operating said electronic device 11 or font information, etc. Further, the fast NVRAM 16 comprises a temporal data storage area 16b for the temporal storage of the data provided in the command/data signal 24. Last (but not least), the fast NVRAM 16 can comprise an additional register area 16c, which can contain additional (different from in the prior art) registers for setting operating parameters of the fast NVRAM 16 or protecting said data or said information during said execution.

For the optimum code protection the write protection can be added to the NVRAM 16. The write protection can be implemented through a command or by a register 16c as mentioned above. In this case it can be possible to use the existing ASICs without hardware changes. It can be possible to include WP (write protect) pin, but then this pin will not be compatible between present DDRs and new DDR NVRAMs.

The operating parameters (set by the registers of the additional register area 16c), of the fast NVRAM 16 can be timings for a particular frequency and/or frequency ranges with a corresponding core voltage range, and/or die ID, etc. Based on these parameters an optimum communication is set up between the ASIC 28 and the memory units 18 and 20. These parameters can be programmed either by a manufacturer of the electronic device 11 or by a memory manufacturer of said fast NVRAM 16.

It is further noted that the fast NVRAM 16 can be used through the same interface as DRAMs but some of the needed functions of DRAM are not needed (pre-charge, auto refresh, self refresh). For the best performance, an optimum DRAM interface to be modified can be a mobile 166 MHz, ×32 DDR. The same modification could be done to any DRAM interface. A reset to get a NVRAM's internal state to a predefined state can be implemented in an optimum way through a DRAM power down mode. This mode can be selected by pulling a CKE (clock Enable) signal low. During a normal mode operation the ASIC 28 can keep the CKE signal high. This method means that every time when the baseband network returns from a power down mode, the NVRAM 16 is in a known state, because all parameters are staying in non-volatile registers. If the ASIC 28 for some reason wants to reset the NVRAM 16 it can pull the CKE low.

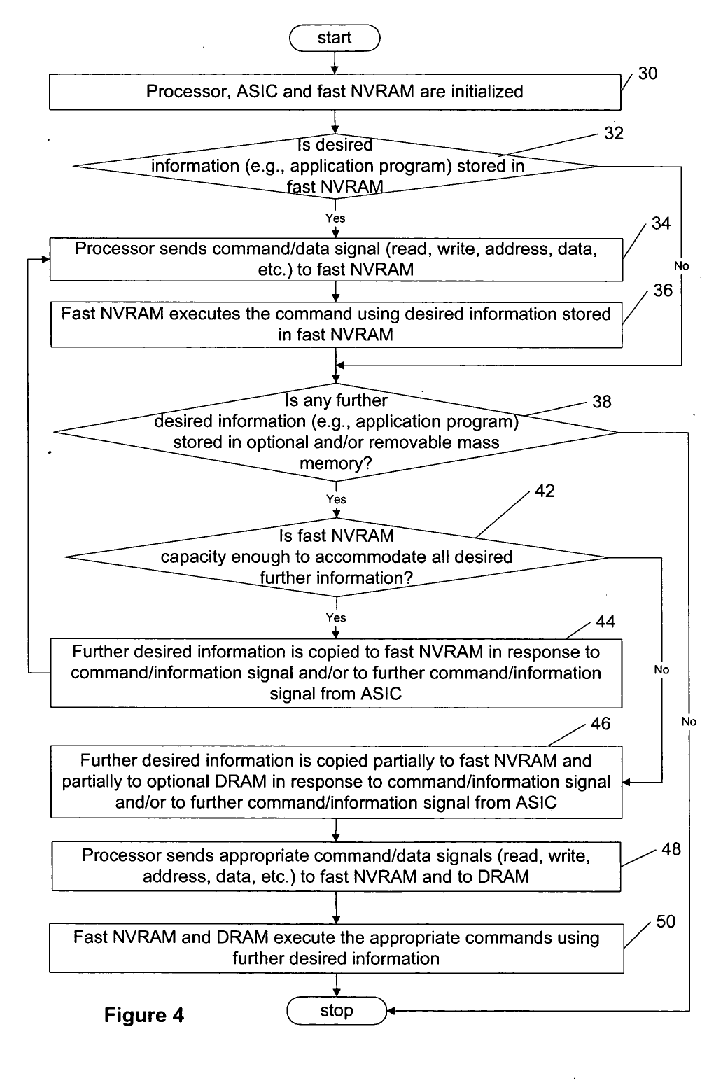

Finally, FIG. 4 is a flow chart demonstrating a performance of a memory module 25 of an electronic device 11 of FIG. l a utilizing the fast NVRAM 16, according to the present invention.

The flow chart of FIG. 4 represents only one possible scenario among many others. In a method according to the present invention, in a first step 30, the processor 10, the ASIC 28 and consequently other components (e.g., including the mass memory 16 and DRAM 18) of the memory module 25 are initialized using a signal provided by the power and reset block 12. In a next step 32, it is determined whether the desired information (e.g., application program) is stored in the fast NVRAM 16. If that is not the case, the process goes to step 38. If however, it is determined that the desired information is stored in the fast NVRAM 16, in a next step 34, the processor 10 sends the command/data signal (read, write, address, data, etc.) 24 to the fast NVRAM 16. In a next step 36, the fast NVRAM 16 executes the command contained in the command/data signal 24 using the desired information stored in the fast NVRAM 16.

In a next step 38, it is determined (e.g., by the ASIC 28) whether any further desired information (e.g., application program) is stored in the optional mass memory 20 and/or in the removable mass memory 27. If that is not the case, the process stops. If however, it is determined (e.g., by the ASIC 28) that the further desired information is stored in the optional mass memory 20 and/or in the removable mass memory 27, in a next step 42, it is determined whether the fast NVRAM 16 has enough capacity to accommodate all the further desired information. If that is not the case, the process goes to step 46. If however, it is determined that the fast NVRAM 16 has enough capacity to accommodate all the further desired information, in a next step 44, the further desired information is copied to the fast NVRAM 16 in response to the command/information signal 26 and/or to the further command/information signal 26a from the ASIC 28. After step 44, the process goes back to step 34 described above.

In a step 46, the further desired information is partially copied to the fast NVRAM 16 and partially to the optional DRAM 18 in response to the command/information signal 26 and/or to the further command/information signal 26a from the ASIC 28. In a next step 48, the processor 10 sends the command/data signal 24 (containing the further command and the still further command) to the fast NVRAM 16 and to the DRAM 18, respectively. In a next step 50, the fast NVRAM 16 and the DRAM 18 execute the further command and the still further command, respectively, contained in the command/data signal 24 using the further desired information (also called the further information and the still further information above) stored in the fast NVRAM 16 and in the DRAM 18, respectively.

1. A memory module of an optionally portable electronic device having a processor which optionally provides an overall operation control of said electronic device, comprising:
a fast non-volatile random access memory, responsive to a command/data signal provided by said processor, for providing a permanent storage of information before said command/data signal is provided, for executing a command contained in said command/data signal using said permanently stored information thus providing a direct communication between said fast non-volatile random access memory and the processor of said optionally portable electronic device.

2. The memory module of claim 1, wherein an interface between the processor and the fast non-volatile random access memory is a double data rate (DDR) type.

3. The memory module of claim 1, wherein the fast non-volatile random access memory provides a temporal storage of data contained in said command/data signal.

4. The memory module of claim 3, wherein said fast non-volatile random access memory comprises:
an information storage area for the permanent storage of said information; and a temporal data storage area for the temporal storage of said data.

5. The memory module of claim 4, wherein said fast non-volatile random access memory further comprises:
at least one register for setting operating parameters of the fast non-volatile random access memory or protecting said data or said information during said execution.

6. The memory module of claim 5, wherein said operating parameters contain timings for a particular frequency, or frequency ranges with a corresponding core voltage range, or both said timings and said frequency ranges.

7. The memory module of claim 5, wherein said protecting contains a write protection.

8. The memory module of claim 1, wherein said information contains an application program for operating said electronic device.

9. The memory module of claim 1, further comprising:
a mass memory, for providing further information in response to a command/information signal; and
an application-specific integration circuit, responsive to said command/data signal, for providing said command/information signal.

10. The memory module of claim 9, wherein said further information is provided to said fast non-volatile random access memory.

11. The memory module of claim 10, wherein said fast non-volatile random access memory executes a further command contained in said command/data signal using said further information.

12. The memory module of claim 9, wherein an interface between the application-specific integration circuit and the fast non-volatile random access memory is a double data rate (DDR) type.

13. The memory module of claim 9, wherein a non-volatile random access memory-integrated circuit (NVRAM-IC) package contains the application-specific integration circuit, the mass memory and the fast non-volatile random access memory, or said non-volatile random access memory-integrated circuit (NVRAM-IC) package contains the application-specific integration circuit and the fast non-volatile random access memory, or said non-volatile random access memory-integrated circuit (NVRAM-IC) package contains the mass memory and the fast non-volatile random access memory.

14. The memory module of claim 9, further comprising:
a dynamic random access memory, responsive to a command/data signal, for providing a storage of said further information, wherein said further information is provided or partially provided to the dynamic random access memory by the mass memory in response to said command/information signal.

15. The memory module of claim 14, wherein a non-volatile random access memory-integrated circuit (NVRAM-IC) package contains the application-specific integration circuit, the mass memory, the fast non-volatile random access memory and the dynamic random access memory, or said non-volatile random access memory-integrated circuit (NVRAM-IC) package contains the application-specific integration circuit and the fast non-volatile random access memory, or said non-volatile random access memory-integrated circuit (NVRAM-IC) package contains the mass memory, the dynamic random access memory and the fast non-volatile random access memory.

16. The memory module of claim 14, wherein said dynamic random access memory executes a still further command contained in said command/data signal using said further information.

17. The memory module of claim 14, wherein said portable electronic device comprises:
a removable mass memory, for providing, in response to a further command/information signal provided by the application-specific integration circuit, still further information to the fast non-volatile random access memory, or to the dynamic random access memory, or to both the fast non-volatile random access memory and to the dynamic random access memory.

18. The memory module of claim 17, wherein said fast non-volatile random access memory or the dynamic random access memory or both the fast non-volatile random access memory and the dynamic random access memory execute a further command or a still further command or both the further command and the still further command contained in said command/data signal using said further information or said still further information or both the further information and the still further information.

19. The memory module of claim 1, wherein said fast non-volatile random access memory is a magneto-resistive random access memory, a ferroelectric random access memory, or an Ovonics memory type.

20. An electronic device, comprising
a processor, for providing a command/data signal and optionally for providing an overall operation control of said electronic device; and
a fast non-volatile random access memory, responsive to the command/data signal, for providing a permanent storage of information before said command/data signal is provided, for executing a command contained in said command/data signal using said stored information.

21. The electronic device of claim 20, further comprising:
a power and reset block, for resetting said processor and for resetting said fast non-volatile random access memory.

22. The electronic device of claim 20, wherein said electronic device is a portable electronic device, a mobile electronic device or a mobile phone.

23. A method for providing a direct communication between a memory module of an optionally portable electronic device and a processor of said electronic device, said processor optionally providing an overall operation control of said electronic device, comprising the steps of:
providing a command/data signal to a fast non-volatile random access memory of said memory module by said processor; and
executing by said fast non-volatile random access memory a command contained in said command/data signal using information permanently stored by said fast non-volatile random access memory before said command/data signal is provided, thus providing a direct communication between said fast non-volatile random access memory and the processor of said optionally portable electronic device.

24. The method of claim 23, further comprises the step of:
determining whether a further information is stored in a mass memory or a still further information is stored in a removable mass memory, wherein said further information or said still further information or both said further information and said still further information are needed to be accessed by the processor.

25. The method of claim 24, if said further information or said still further information or both said further information and said still further information are needed to be accessed by the processor, the method further comprises the step of:
determining by an application-specific integration circuit whether said fast non-volatile random access memory has enough of a storage area to accommodate said needed information.

26. The method of claim 25, wherein an interface between the application-specific integration circuit and the fast non-volatile random access memory is a double data rate (DDR) type.

27. The method of claim 25, if said fast non-volatile random access memory has enough of said storage area to accommodate said needed information, the method further comprises the steps of:
copying said needed information to said fast non-volatile random access memory in response to a command/information signal provided by the application-specific integration circuit to a mass memory, or to a further command/information signal provided by the application-specific integration circuit to a removable mass memory or in response to both the command/information signal and the further command/information signal; and
executing by said fast non-volatile random access memory a further command contained in the command/data signal using said needed information copied to said fast non-volatile random access memory before said command/data signal is provided.

28. The method of claim 25, if said fast non-volatile random access memory does not have enough of said storage area to accommodate said needed information, the method further comprises the steps of:
copying said needed information partially to said fast non-volatile random access memory and partially to a dynamic random access memory in response to a command/information signal provided by the application-specific integration circuit to a mass memory, or to a further command/information signal provided by the application-specific integration circuit to a removable mass memory or in response to both the command/information signal and the further command/information signal; and
executing a further command contained in the command/data signal by said fast non-volatile random access memory and executing a still further command also contained in the command/data signal by said dynamic random access memory using said needed information copied to said fast non-volatile random access memory and to said dynamic random access memory before said command/data signal is provided.

29. The method of claim 23, wherein an interface between the processor and the fast non-volatile random access memory is a double data rate (DDR) type.

30. The method of claim 23, wherein said fast non-volatile random access memory is a magneto-resistive random access memory, a ferroelectric random access memory, or an Ovonics memory type.

31. The method of claim 23, wherein said electronic device is a portable electronic device, a mobile electronic device or a mobile phone.

32. A computer program product comprising: a computer readable storage structure embodying computer program code thereon for execution by a computer processor with said computer program code, characterized in that it includes instructions for performing all or selected steps of the method of claim 28 indicated as being performed by any component of the memory module or their combination thereof.
